(19) United States
(12) Patent Application Publication
(10) Pub. No.: US 2008/0159115 A1
(43) Pub. Date: Jul. 3, 2008

(54) Optical recording medium

(75) Inventors: Takashi Kikukawa, Tokyo (JP); Koji Mishima, Tokyo (JP); Toshiki Aoi, Sakura-shi (JP)

Correspondence Address: MATHEWS, SHEPHERD, MCKAY, & BRUNEAU, P.A., 29 THANET ROAD, SUITE 201, PRINCETON, NJ, 08540, US

(73) Assignee: TDK Corporation

(21) Appl. No.: 12/005,735

(22) Filed: Dec. 28, 2007

(30) Foreign Application Priority Data
Dec. 28, 2006 (JP) 2006-353758

(51) Int. Cl. G11B 7/24

(52) U.S. Cl. 369/275.1

(57) ABSTRACT

An optical recording medium capable of both recording in conformity to BD standard and recording/reading in conformity to DVD or CD standard. The optical recording medium includes: at least one recording layer located in the range of 40 to 120 μm away from a light incident surface, the recording layer having a light absorption characteristic which enables write-once recording using a laser optical system having a wavelength in the range of 400 to 410 nm and a numerical aperture in the range of 0.80 to 0.90 and having a light absorption characteristic which disables write-once recording using a laser optical system having a wavelength in the range of 620 to 660 nm and a numerical aperture in the range of 0.55 to 0.65; and at least one recording layer located in the range of 570 to 630 μm away from the light incident surface, the recording layer exhibiting any one of information retention modes selected from among read-only, write-once, and rewritable using the laser optical system having a wavelength in the range of 620 to 660 nm and a numerical aperture in the range of 0.55 to 0.65.

### BACKGROUND OF THE INVENTION

1. Field of the Invention

The present invention relates to an optical recording medium which is recorded and read using light, and in particular to an optical recording medium that has a plurality of recording layers.

2. Description of the Related Art

CD-DA, CD-ROM, CD-R, CD-RW, DVD-ROM, DVD-R, DVD+/−RW, DVD-RAM, and the like are now widely used to view digital moving-image contents and to record digital data. Meanwhile, in order to cope with high-definition moving images and handle digital data of greater size, so-called next-generation DVDs which are capable of storing both moving images and data of greater size than CDs and conventional DVDs have been moving toward the stage of commercialization. Recording media based on the Blu-ray Disc (BD) standard, being one of standards for next-generation DVDs, have a capacity of 25 GB per layer. Apparatuses for recording data on and reading data from a BD-based recording medium are often configured so that they can also perform recording and reading processing using past DVD standards (see Japanese Patent Application Laid-Open No. 2005-56487).

Now, optical recording media conforming to the next-generation DVD standards have the problem of incompatibility with conventional DVD standards. For example, optical recording media of the next-generation DVD standards that contains movies or other content cannot be read even if loaded into conventional DVD players. In order to solve this problem, an optical recording medium which includes two recording layers, including a read-only recording layer corresponding to the conventional DVD standard and a read-only recording layer corresponding to the HD-DVD standard, being one of the next-generation DVD standards has been proposed (see Japanese Patent Application Laid-Open No. 2006-164325). This optical recording medium can be read in both a conventional DVD standard player and in a next-generation DVD standards player.

With the recent prevalence of digital HDTV broadcasting and rich contents such as music, there has been an increasing need for the collective recording and storage of enormous amounts of information. As a result, demand has arisen for an optical recording media with an increased recording capacity, and BD-based recording media that are capable of achieving large volume recording have been gaining attention. Nevertheless, recording and reading apparatuses dedicated to conventional CD- and DVD-based recording media, which are already in widespread use, do not support BD-based recording media. Therefore, it is first necessary to purchase a new recording and reading apparatus dedicated to the BD standard before using BD-based recording media. Since users who have previously owned recording and reading apparatuses dedicated to the conventional CD or DVD standards tend to continue purchasing recordable recording media such as CD-R, CD-RW, DVD-R, and DVD+/−RW, there has been a problem regarding the slowness of diffusion of the BD standard into the market.

### SUMMARY OF THE INVENTION

The present invention has been developed in view of the foregoing problem. It is thus an object of the present invention to provide a recording medium which can be recorded and read under the conventional CD or DVD standards when loaded in a recording and reading apparatus that supports the conventional CD or DVD standards, and is also capable of write-once recording and reading processing under the BD standard when loaded in a recording and reading apparatus that supports the BD standard.

Following intensive studies, the inventors have achieved the foregoing object with the following means.

A first aspect of the present invention is an optical recording medium including: at least one recording layer located in the range of 40 to 120 μm away from a light incident surface, the recording layer having a light absorption characteristic which enables write-once recording using a laser optical system having a wavelength in the range of 400 to 410 nm and a numerical aperture in the range of 0.80 to 0.90 and having a light absorption characteristic which disables write-once recording using a laser optical system having a wavelength in the range of 620 to 660 nm and a numerical aperture in the range of 0.55 to 0.65; and at least one recording layer located in the range of 570 to 630 μm away from the light incident surface, the recording layer exhibiting any one of information retention modes selected from among read-only, write-once, and rewritable using the laser optical system having a wavelength in the range of 620 to 660 nm and a numerical aperture in the range of 0.55 to 0.65.

A second aspect of the present invention is an optical recording medium including: at least one optical recording layer located in the range of 40 to 120 μm away from a light incident surface, the optical recording layer having a light absorption characteristic which enables write-once recording using a laser optical system having a wavelength in the range of 400 to 410 nm and a numerical aperture in the range of 0.80 to 0.90 and having a light absorption characteristic which disables write-once recording using a laser optical system having a wavelength in the range of 770 to 795 nm and a numerical aperture in the range of 0.45 to 0.50; and at least one recording layer located in the range of 1100 to 1300 μm away from the light incident surface, the recording layer exhibiting any one of information retention modes selected from among read-only, write-once, and rewritable using the laser optical system having a wavelength in the range of 770 to 795 nm and a numerical aperture in the range of 0.45 to 0.50.

A third aspect of the present invention is an optical recording medium including: at least one recording layer located in the range of 40 to 120 μm away from a light incident surface, the recording layer having a light absorptance of 10% or higher when using a laser optical system having a wavelength in the range of 400 to 410 nm and a numerical aperture in the range of 0.80 to 0.90 and having a light transmittance of 70% or higher when using a laser optical system having a wavelength in the range of 620 to 660 nm and a numerical aperture in the range of 0.55 to 0.65; and at least one recording layer located in the range of 570 to 630 μm away from the light incident surface, the recording layer exhibiting any one of information retention modes selected from among read-only, write-once, and rewritable using the laser optical system having a wavelength in the range of 620 to 660 nm and a numerical aperture in the range of 0.55 to 0.65.

A fourth aspect of the present invention is an optical recording medium including: at least one recording layer located in the range of 40 to 120 μm away from a light incident surface, the recording layer having a light absorptance of 10% or higher when using a laser optical system having a wavelength in the range of 400 to 410 nm and a numerical aperture in the range of 0.80 to 0.90 and having a light transmittance of 70% or higher when using a laser optical system having a wavelength in the range of 770 to 795 nm and a numerical aperture in the range of 0.45 to 0.50; and at least one recording layer located in the range of 1100 to 1300 μm away from the light incident surface, the recording layer exhibiting any one of information retention modes selected from among read-only, write-once, and rewritable using the laser optical system having a wavelength in the range of 770 to 795 nm and a numerical aperture in the range of 0.45 to 0.50.

The optical recording medium according to any one of the foregoing aspects of the present invention, wherein the recording layer located in the range of 40 to 120 μm away from a light incident surface includes at least a recording film made of bismuth oxide.

A fifth aspect of the present invention is an optical recording medium including: at least one first recording layer located in the range of 40 to 120 μm away from a light incident surface, the first recording layer including a recording film made of bismuth oxide and having a light absorptance of 10% or higher when using a laser optical system having a wavelength in the range of 400 to 410 nm and a numerical aperture in the range of 0.80 to 0.90; and at least one recording layer located in the range of 570 to 630 μm away from the light incident surface, the recording layer exhibiting any one of information retention modes selected from among read-only, write-once, and rewritable using a laser optical system having a wavelength in the range of 620 to 660 nm and a numerical aperture in the range of 0.55 to 0.65.

A sixth aspect of the present invention is an optical recording medium including: at least one first recording layer located in the range of 40 to 120 μm away from a light incident surface, the first recording layer including at least a recording film made of bismuth oxide and having a light absorptance of 10% or higher when using a laser optical system having a wavelength in the range of 400 to 410 nm and a numerical aperture in the range of 0.80 to 0.90; and at least one recording layer located in the range of 1100 to 1300 μm away from the light incident surface, the recording layer exhibiting any one of information retention modes selected from among read-only, write-once, and rewritable using a laser optical system having a wavelength in the range of 770 to 795 nm and a numerical aperture in the range of 0.45 to 0.50.

The use of the optical recording medium according to the present invention provides the excellent effect where a recording and reading apparatus that supports the conventional CD or DVD standards can perform recording and reading processing that conforms to the conventional CD or DVD standards, and a recording and reading apparatus that supports the BD standard can perform write-once recording and reading processing that conforms to the BD standard. This makes it possible even for users who do not own any recording and reading apparatus that supports the BD standard to use this optical recording medium. Consequently, it is possible for users who purchase recording and reading apparatuses that support the BD standard in the future to switch between optical recording media easily. In addition, information recorded on recording media conforming to the conventional CD and DVD standards and information recorded on recording media conforming to the BD standard can be saved on this optical recording medium collectively.

### BRIEF DESCRIPTION OF THE DRAWINGS

The above and other objects, features and advantages of the present invention will become apparent from the following description and appended claims, taken in conjunction with the accompanying drawings.

FIG. 1 is a diagram showing the general configuration of an optical recording medium according to a first embodiment of the present invention;

FIGS. 2A and 2B are partial sectional views showing the layers of the optical recording medium;

FIGS. 3A to 3C are partial sectional views showing the layers of the optical recording medium according to a second embodiment of the present invention;

FIGS. 4A to 4C are partial sectional views showing the layers of the optical recording medium according to a third embodiment of the present invention;

FIGS. 5A and 5B are partial sectional views showing the layers of the optical recording medium according to a fourth embodiment of the present invention;

FIGS. 6A to 6C are partial sectional views showing the layers of the optical recording medium according to a fifth embodiment of the present invention; and

FIGS. 7A to 7C are partial sectional views showing the layers of the optical recording medium according to a sixth embodiment of the present invention.

### DETAILED DESCRIPTION OF THE PREFERRED EMBODIMENTS

Next, embodiments of the present invention will be described in detail with reference to the drawings.

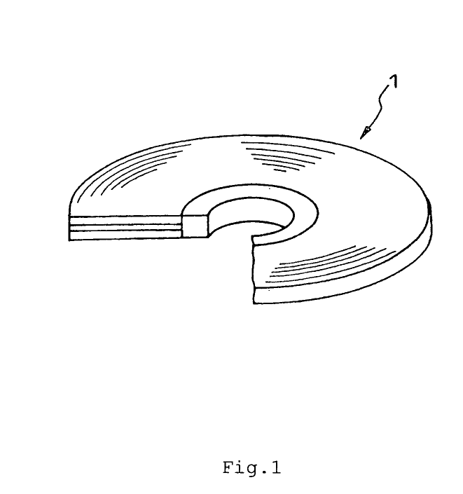

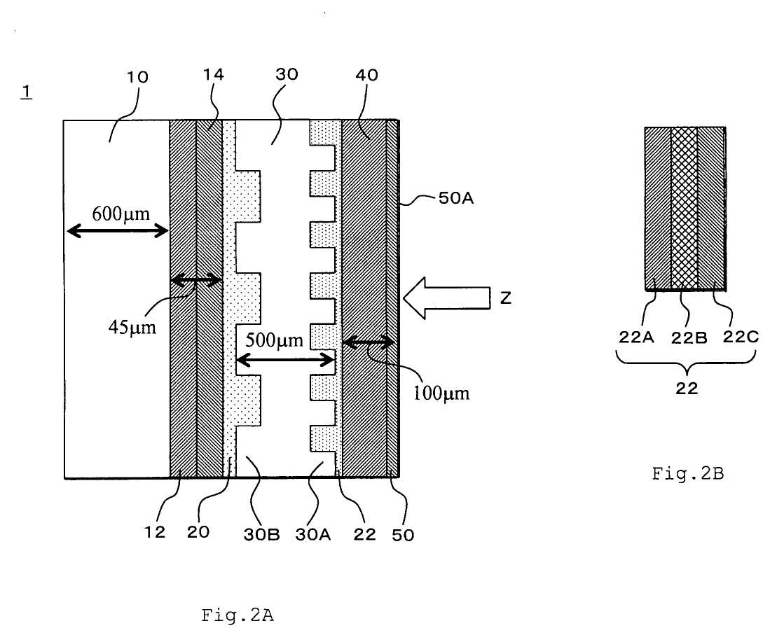

FIG. 1 shows an optical recording medium 1 according to a first embodiment of the present invention. As shown in FIG. 1, this optical recording medium 1 is a disc-shaped medium having an outer diameter of approximately 120 mm and a thickness of approximately 1.2 mm. As shown in FIG. 2A, this optical recording medium 1 is a multilayered medium having two recording layers. The optical recording medium 1 is configured to include a dummy polycarbonate substrate 10, an adhesive layer 12, a top coat layer 14, a DVD-ROM recording layer 20, a spacer polycarbonate substrate layer 30, a selective recording layer 22, a light-transparent cover layer 40, and a hard coat layer 50 which are stacked in this order.

The selective recording layer 22, the spacer polycarbonate substrate layer 30, the cover layer 40, and the hard coat layer 50 are all transparent to light, and transmit laser light Z that is incident on a light incident surface 50A of the hard coat layer 50. This makes it possible for the laser light Z to reach the selective recording layer 22 and the DVD-ROM recording layer 20.

The dummy polycarbonate substrate 10 has a thickness of 600 μm. The adhesive layer 12 and the top coat layer 14 have a thickness of 45 μm in total. The adhesive layer 12 has the function of integrating the DVD-ROM recording layer 20 and the dummy polycarbonate substrate 10. The spacer polycarbonate substrate layer 30 has a thickness of 500 μm and keeps the selective recording layer 22 and the DVD-ROM recording layer 20 at a predetermined distance away from each other. One of the sides of this spacer polycarbonate substrate layer 30 includes a spiral groove 30A corresponding to the BD standard. The other side thereof is provided with ROM pits that correspond to the DVD standards. The cover layer 40 and the hard coat layer 50 have a thickness of 98 μm and 2 μm, respectively, or a thickness of 100 μm in total.

In the present optical recording medium 1, the distance from the light incident surface 50A to the selective recording layer 22 is thus approximately 100 μm. The distance from the light incident surface 50A to the DVD-ROM recording layer 20 is approximately 600 μm. The selective recording layer 22 is made consistent with the Blu-ray Disc standard, including the recording capacity (25 GB).

Aside from the polycarbonate resin, the dummy polycarbonate substrate 10 and the spacer polycarbonate substrate layer 30 may also be made of materials such as olefin resin, acrylic resin, epoxy resin, polystyrene resin, polyethylene resin, polypropylene resin, silicone resin, fluorine-based resin, ABS resin, and urethane resin. Of these, polycarbonate resin and olefin resin are preferable in view of both workability and moldability. It should be also appreciated that various materials such as glass and ceramic may also be used in addition to resin materials.

The selective recording layer 22 is preferably arranged within the range of 40 to 120 μm away from the light incident surface 50A. As stated previously, the selective recording layer 22 in the present embodiment is located at 100 μm away from the light incident surface 50A. The selective recording layer 22 has a high light absorption characteristic to first laser light Z having a wavelength in the range of 400 to 410 nm and a numerical aperture in the range of 0.80 to 0.90 (i.e., laser light corresponding to the BD standard). The selective recording layer 22 functions as a write-once recording layer with a light absorptance of 10% or higher. Meanwhile, with respect to second laser light Z having a wavelength in the range of 620 to 660 nm and a numerical aperture in the range of 0.55 to 0.65 (i.e., laser light corresponding to the conventional DVD standards), the selective recording layer 22 has a relatively low light absorption characteristic when compared with that of the first laser light Z. The selective recording layer 22 exhibits a light transmittance of 70% or higher so as to not allow recording functions to occur. In the present embodiment, this recording layer is referred to as a “selective” recording layer because it accepts writing by laser light that conforms to the BD standard and rejects writing by laser light that conforms to the conventional DVD standards. For example, this selective recording layer 22 exhibits an extinction coefficient (=absorption coefficient: the imaginary part of a complex refractive index) of 0.05 or higher and a light absorptance of 12% when using the first laser light Z having a wavelength of 405 nm and a numerical aperture of 0.85. When using the second laser light Z having a wavelength of 650 nm and a numerical aperture of 0.60, it exhibits an extinction coefficient of 0.5 or lower and a light transmittance of 73%. It should be appreciated that if the data retention mode is write-once, recording marks are formed in an irreversible fashion and are thus non-erasable.

As shown enlarged in FIG. 2B, this selective recording layer 22 has the structure where a bismuth oxide recording film 22B is sandwiched between two titanium oxide films, or dielectric films, 22A and 22B. These titanium oxide (TiO₂) films 22A and 22C have a thickness of 10 nm. The bismuth oxide (BiO_{2.1}) recording film 22B has a thickness of 30 nm. This selective recording layer 22 is deposited in the groove 30A and land of the spacer polycarbonate substrate layer 30 by sputtering. It should be noted that it is the bismuth oxide recording film 22B that records information through thermal reaction. When using this film stacking, the selective recording layer 22 exhibits an extinction coefficient of 0.2 when using the laser light having a wavelength of 407 nm, and an extinction coefficient of near zero when using the laser light having a wavelength of 650 nm. Note that the groove 30A functions as a guide track for the first laser light Z when recording data. The first laser light Z proceeding along the groove 30A is modulated in energy intensity to form recording marks on the selective recording layer 22 located in the groove 30A. While the present embodiment deals with the case where recording marks 46 are formed in the groove 42, it should be appreciated that they may be formed on the land or both in the groove and on the land.

The DVD-ROM recording layer 20 is arranged in the range of 570 to 630 μm away from the light incident surface 50A. As stated previously, the DVD-ROM recording layer 20 is located at approximately 600 μm away from the light incident surface 50A in the present embodiment. The DVD-ROM recording layer 20 is formed by depositing an Al—Cr film (Al:Cr=98:2 (mol %)) by sputtering onto the ROM pits 30B which are formed in the spacer polycarbonate substrate layer 30.

A method of recording and reading information on/from this optical recording medium 1 will now be described.

When recording information on the selective recording layer 22, the selective recording layer 22 is irradiated with pulses of the first laser light Z that is set to the recording power level. In this instance, the beam spot is focused on the selective recording layer 22. Since the first laser light Z has a wavelength in the range of 400 to 410 nm and a numerical aperture in the range of 0.80 to 0.90, the selective recording layer 22 exhibits an extinction coefficient of 0.05 or higher with a light absorptance of 10% or higher. As a result, the selective recording layer 22 absorbs the light of the beam spot and converts it into heat, which causes reaction, thereby forming recording marks. Incidentally, when reading information recorded in this way, the selective recording layer 22 is irradiated with the first laser light Z that is set to reading power which is lower than the recording power.

When reading information previously recorded on the DVD-ROM recording layer 20 in the form of the ROM pits 30B, the DVD-ROM recording layer 20 is irradiated with the second laser light Z that is set to the reading power level. In this instance, the beam spot is focused on the DVD-ROM recording layer 20 during reading operation. Since the second laser light Z has a wavelength in the range of 620 to 660 nm and a numerical aperture in the range of 0.55 to 0.65, the selective recording layer 22 exhibits an extinction coefficient of 0.5 or lower with a light transmittance of 70% or higher. In addition to the fact that the beam spot of the second laser light Z is not focused on the selective recording layer 22, the amount of light absorption also decreases because of the material used. This prevents the selective recording layer 22 from being reactioned by the heat of the second laser light Z. As a result, the selective recording layer 22 do not deteriorate reading quality of the DVD-ROM recording layer 20.

According to the optical recording medium 1, a first laser optical system that supports the BD standard can be used to record and read information on/from the selective recording layer 22. In addition, a second laser optical system that supports the conventional DVD standards can be used to read information recorded on the DVD-ROM recording layer 20. It is therefore possible to achieve information writing that conforms to the BD standard and reading that conforms to the conventional DVD standards at the same time, so that this optical recording medium 1 can be read even with a DVD-ROM player that does not support the BD standard. It should be understood that BD recording and reading apparatuses can also use this optical recording medium 1. DVD-compatible BD recording and reading apparatuses can record and read data stored on both the selective recording layer 22 and the DVD-ROM recording layer 20.

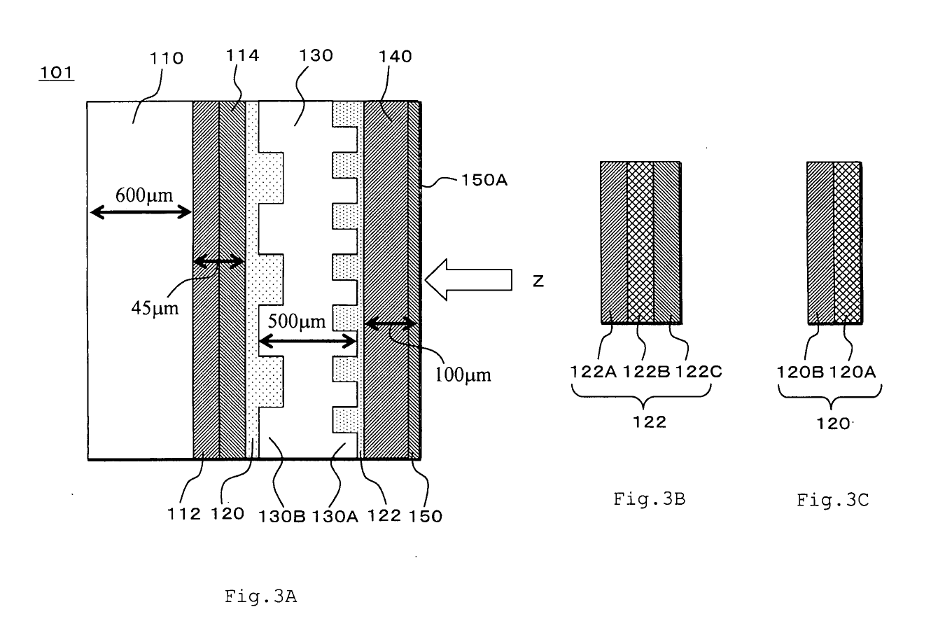

An optical recording medium 101 according to a second embodiment of the present invention will now be described with reference to FIG. 3. In the following description and drawings, components of this optical recording medium 101 that are either similar or identical to those of the optical recording medium 1 described in the first embodiment will be designated by reference numerals having the same lower two digits. A description of each individual component will thus be omitted.

As shown in FIG. 3A, the optical recording medium 101 is configured to include a dummy polycarbonate substrate 110, an adhesive layer 112, a DVD-R recording layer 120, a spacer polycarbonate substrate layer 130, a selective recording layer 122, a light-transparent cover layer 140, and a hard coat layer 150 which are stacked in this order. As shown in FIG. 3B, the selective recording layer 122 has exactly the same configuration as that of the first embodiment.

The spacer polycarbonate substrate layer 130 has a thickness of 500 μm and keeps the selective recording layer 122 and the DVD-R recording layer 120 at a predetermined distance away from each other. The cover layer 140 and the hard coat layer 150 have a thickness of 98 μm and 2 μm, respectively, or a thickness of 100 μm in total.

In this optical recording medium 101, the distance from the light incident surface 150A to the selective recording layer 122 is thus approximately 100 μm. The distance from the light incident surface 150A to the DVD-R recording layer 120 is approximately 600 μm. The selective recording layer 122 is made consistent with the Blu-ray Disc standard, including the recording capacity (25 GB). The DVD-R recording layer 120 is made consistent with the DVD-R standard for write-once recording.

One of the sides of the spacer polycarbonate substrate layer 130 has a groove 130A which is intended to receive the selective recording layer 122. The other side thereof has a groove 130B which is intended to receive the DVD-R recording layer 120.

As shown enlarged in FIG. 3C, the DVD-R recording layer 120 has an organic dye recording film 120A which is spin-coated in the groove 130B and land of the spacer polycarbonate substrate layer 130, and a reflective film 120B which is deposited on this organic dye recording film 120A. The organic dye recording film 120A causes a change in the chemical state of the information recorded when irradiated with laser light of high power. It should be appreciated that recorded areas cannot be rewritten (write-once) since the organic dye causes an irreversible chemical change. The present embodiment preferably uses azo-based or cyanine-based organic dyes, which are optimized to react to the laser wavelength of 650 nm for use in the DVD-R standard with high sensitivity. The reflective film 120B is made of a metallic material, and reflects the laser light. This allows the DVD-R recording layer 120 to range in reflectance from 45% to 85%.

When recording information on the selective recording layer 122 of the optical recording medium 101, the selective recording layer 122 is irradiated with pulses of a first laser light Z that is set to the recording power level, through the cover layer 140 and the hard coat layer 150. In this instance, the beam spot is focused on the selective recording layer 122. The first laser light Z has a wavelength in the range of 400 to 410 nm and a numerical aperture in the range of 0.80 to 0.90, and the selective recording layer 122 thus exhibits an extinction coefficient of 0.05 or higher. As a result of this, the selective recording layer 122 absorbs the light of the beam spot and converts it into heat, and information is recorded by the heat.

Now, when recording information on the DVD-R recording layer 120, the DVD-R recording layer 120 is irradiated with the second laser light Z that is set to the recording power level. This beam spot is focused on the DVD-R recording layer 120, so that the second laser light Z is absorbed by the organic dye recording film 120A of the DVD-R recording layer 120 effectively and converted into heat to form recording marks. The second laser light Z has a wavelength in the range of 620 to 660 nm and a numerical aperture in the range of 0.55 to 0.65, and the selective recording layer 122 thus exhibits an extinction coefficient of 0.5 or lower. This can prevent the selective recording layer 122 from being reactioned by the second laser light Z.

According to the optical recording medium 101, a first laser optical system that supports the BD standard can be used to record and read information on/from the selective recording layer 122. In addition, a second laser optical system that supports the DVD-R standard can be used to record information on the DVD-R recording layer 120 alone. Consequently, the single recording medium 110 can be subjected to both BD-based writing and DVD-R based writing at the same time.

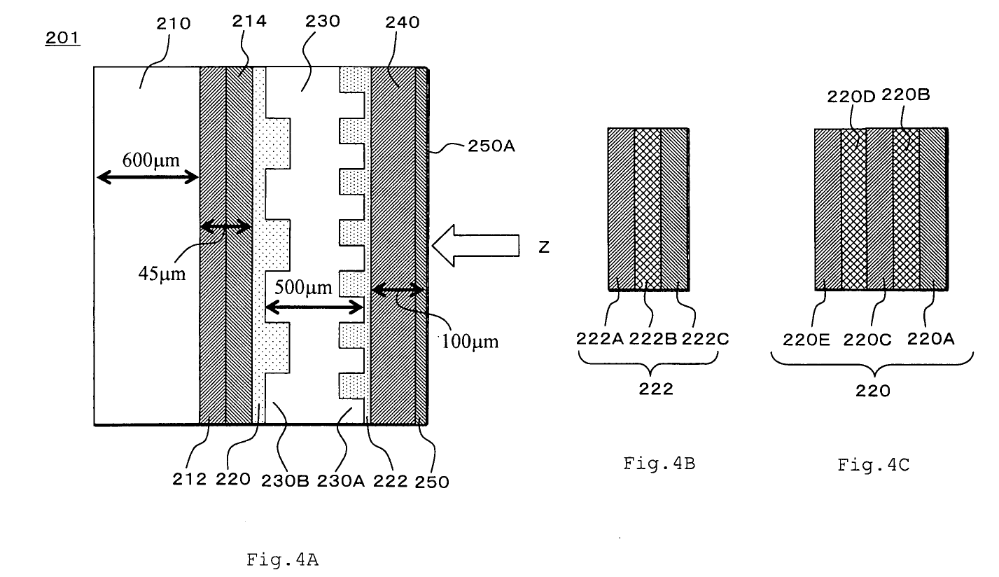

An optical recording medium 201 according to a third embodiment of the present invention will be described with reference to FIG. 4. In the following description and drawings, components in the optical recording medium 201 that are either similar or identical to those of the optical recording medium 1 described in the first embodiment will be designated by reference numerals having the same lower two digits. A description of each individual component will thus be omitted.

As shown in FIG. 4A, the optical recording medium 201 is configured to include a dummy polycarbonate substrate 210, an adhesive layer 212, a DVD-RW recording layer 220, a spacer polycarbonate substrate layer 230, a selective recording layer 222, a light-transparent cover layer 240, and a hard coat layer 250 which are stacked in this order. As shown in FIG. 4B, the selective recording layer 222 has exactly the same configuration as that of the first embodiment.

The spacer polycarbonate substrate layer 230 has a thickness of 500 μm and keeps the selective recording layer 222 and the DVD-RW recording layer 220 at a predetermined distance away from each other. The cover layer 240 and the hard coat layer 250 have a thickness of 98 μm and 2 μm, respectively, or a thickness of 100 μm in total. In the optical recording medium 201, the distance from the light incident surface 250A to the selective recording layer 222 is thus approximately 100 μm. The distance from the light incident surface 250A to the DVD-RW recording layer 220 is approximately 600 μm. The selective recording layer 222 is made consistent with the Blu-ray Disc standard, including the recording capacity (25 GB). The DVD-RW recording layer 220 is made consistent with the DVD-RW standard for rewritable recording.

One of the sides of the spacer polycarbonate substrate layer 230 has a groove 230A which is intended to receive the selective recording layer 222. The other side has a groove 230B which is intended to receive the DVD-RW recording layer 220.

As shown enlarged in FIG. 4C, the DVD-RW recording layer 220 includes a protective film 220A, a phase change material film 220B, a protective film 220C, a reflective film 220D, and a protective film 220E. The protective film 220A is deposited in the groove 230B and land of the spacer polycarbonate substrate layer 230. The phase change material film 220B is deposited on the protective film 220A. The protective film 220C is deposited on the phase change material film 220B. The reflective film 220D is deposited on the protective film 220C. The protective film 220E is deposited on the reflective film 220D. When the phase change material film 220B is irradiated with the second laser light Z of high power, the phase change material is melted and cooled quickly into an amorphous state (recorded state) resulting in a drop in reflectivity. If the phase change material is irradiated with the laser light of medium power for gradual heating and gradual cooling, however, the phase change material enters a crystalline state (erased state) resulting in a return to a high reflectivity. Since the phase change material film 220B causes reversible changes, it is possible to rewrite previously-recorded areas (rewritable type).

When recording information on the selective recording layer 222 of the optical recording medium 201, the selective recording layer 222 is irradiated with pulses of the first laser light Z that is set to the recording power level, through the cover layer 240 and the hard coat layer 250. In this instance, the beam spot is focused on the selective recording layer 222. Since the first laser light Z has a wavelength in the range of 400 to 410 nm and a numerical aperture in the range of 0.80 to 0.90, the selective recording layer 222 exhibits an extinction coefficient of 0.05 or higher. As a result, the selective recording layer 222 absorbs the light of the beam spot and converts it into heat, and information is recorded by the heat.

Now, when recording information on the DVD-RW recording layer 220, the DVD-RW recording layer 220 is irradiated with pulses of the second laser light Z that is set to a high power (recording power). In this instance, the beam spot is focused on the DVD-RW recording layer 220. With the laser light of high power, the phase change material film 220B of the DVD-RW recording layer 220 is melted and cooled quickly to form amorphous recording marks. The information in the DVD-RW recording layer 220 can be erased using the second laser light Z of medium power (erasing power). Meanwhile, the selective recording layer 222 exhibits an extinction coefficient of 0.5 or lower since the second laser light Z has a wavelength in the range of 620 to 660 nm and a numerical aperture in the range of 0.55 to 0.65. This can prevent the selective recording layer 122 from being reactioned by the second laser light Z.

According to the optical recording medium 201, a first laser optical system that supports the BD standard can be used to record and read information on/from the selective recording layer 222. In addition, a second laser optical system that supports the DVD-RW standard can be used to record and erase information on/from the DVD-RW recording layer 220 alone. Consequently, the one single recording medium 201 can be subjected to both BD-based writing and DVD-RW based writing at the same time.

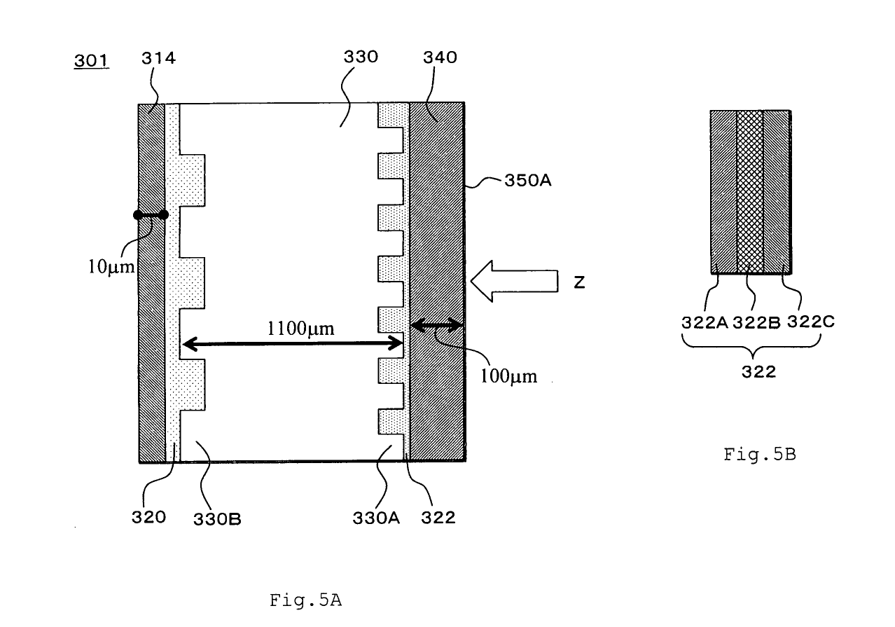

An optical recording medium 301 according to a fourth embodiment of the present invention will now be described with reference to FIG. 5. In the following description and drawings, components in the optical recording medium 301 that are either similar or identical to those of the optical recording medium 1 described in the first embodiment will be designated by reference numerals with the same lower two digits. A description of each individual component will thus be omitted.

As shown in FIG. 5A, the optical recording medium 301 is configured to include a top coat layer 314, a CD-ROM recording layer 320, a spacer polycarbonate substrate layer 330, a selective recording layer 322, and a light-transparent cover layer 340 which are stacked in this order. As shown in FIG. 5B, the selective recording layer 322 has exactly the same configuration as that of the first embodiment.

The spacer polycarbonate substrate layer 330 has a thickness of 1100 μm, and keeps the selective recording layer 322 and the CD-ROM recording layer 320 at a predetermined distance away from each other. The light-transparent cover layer 340 has a thickness of 100 μm.

In the present optical recording medium 301, the distance from the light incident surface 350A to the selective recording layer 322 is thus approximately 100 μm. The distance from the light incident surface 350A to the CD-ROM recording layer 320 is approximately 1200 μm. The selective recording layer 322 is made consistent with the Blu-ray Disc standard, including the recording capacity (25 GB). The CD-ROM recording layer 320 is made consistent with the read-only CD-ROM standard.

One of the sides of the spacer polycarbonate substrate layer 330 has a groove 330A which is intended to receive the selective recording layer 322. The other side thereof is provided with ROM pits 330B which are intended for the CD-ROM recording layer 320.

The CD-ROM recording layer 320 is deposited in the ROM pits 330B and spaces of the spacer polycarbonate substrate layer 330. This CD-ROM recording layer 320 is formed by depositing a film of Al and 2.0-mol % Cr in the ROM pits 330B by sputtering.

When recording information on the selective recording layer 322 of the optical recording medium 301, the selective recording layer 322 is irradiated with pulses of the first recording layer Z that is set to the recording power level. In this instance, the beam spot is focused on the selective recording layer 322. Since the first laser light Z has a wavelength in the range of 400 to 410 nm and a numerical aperture in the range of 0.80 to 0.90, the selective recording layer 322 exhibits an extinction coefficient of 0.05 or higher. As a result of this, the selective recording layer 322 absorbs the light of the beam spot and converts it into heat, and information is recorded by the heat.

When reading information previously recorded on the CD-ROM recording layer 320 in the form of the ROM pits 330B, the CD-ROM recording layer 320 is irradiated with third laser light Z that is set to the reading power level. The third laser light Z is of CD optical system, having a wavelength in the range of 770 to 795 nm and a numerical aperture in the range of 0.45 to 0.50. Using the third laser light Z, information is thus read from the CD-ROM recording layer 320. Meanwhile, the selective recording layer 322 exhibits an extinction coefficient of 0.5 or lower when using the third laser light Z having a wavelength in the range of 770 to 795 nm and a numerical aperture in the range of 0.45 to 0.55. In addition to the fact that the beam spot of the third laser light Z is not focused on the selective recording layer 322, the amount of light absorption in the selective recording layer 322 also decreases because of the material. This can prevent the selective recording layer 322 from accidental writing due to the heat of the third laser light Z.

According to the optical recording medium 301, a first laser optical system that supports the BD standard can be used to record and read information on/from the selective recording layer 322. Moreover, a third laser optical system that supports the CD-ROM standard can be used to read information from the CD-ROM recording layer 320. Consequently, the one single recording medium 301 can be subjected to BD-based recording and reading and to CD-ROM based reading at the same time.

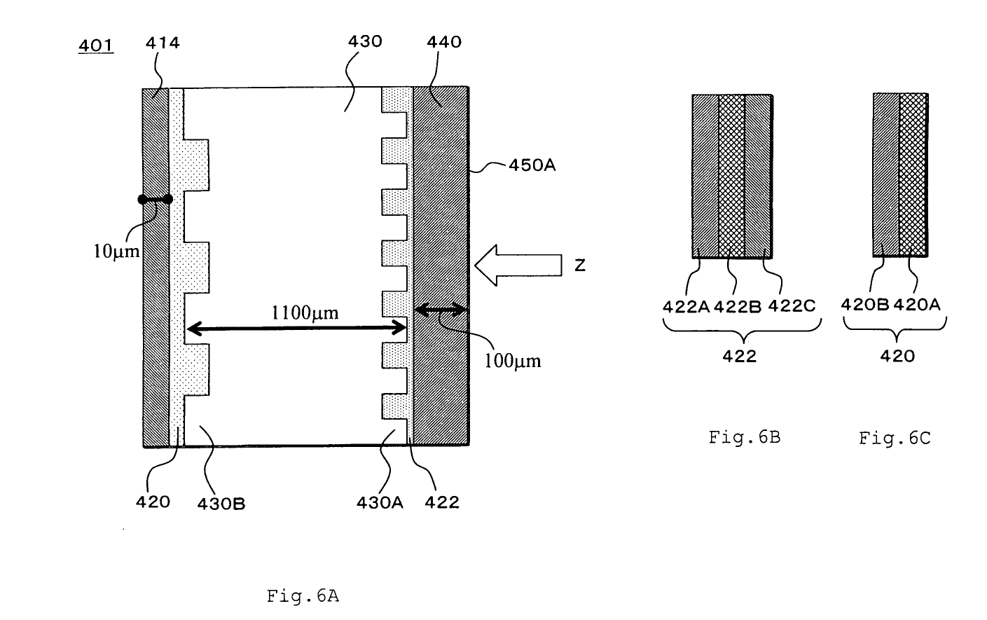

An optical recording medium 401 according to a fifth embodiment of the present invention will now be described with reference to FIG. 6. In the following description and drawings, components in the optical recording medium 401 that are either similar or identical to those of the optical recording medium 301 described in the fourth embodiment will be designated by reference numerals with the same lower two digits. A description of each individual component will thus be omitted.

As shown in FIG. 6A, this optical recording medium 401 is configured to include a top coat layer 414, a CD-R recording layer 420, a spacer polycarbonate substrate layer 430, a selective recording layer 422, and a light-transparent cover layer 440 which are stacked in this order. As shown in FIG. 6B, the selective recording layer 422 has exactly the same configuration as that of the fourth embodiment.

The spacer polycarbonate substrate layer 430 has a thickness of 1100 μm and keeps the selective recording layer 422 and the CD-R recording layer 420 at a predetermined distance away from each other. The cover layer 440 has a thickness of approximately 100 μm.

In the optical recording medium 401, the distance from the light incident surface 450A to the selective recording layer 422 is thus approximately 100 μm. The distance from the light incident surface 450A to the CD-R recording layer 420 is approximately 1200 μm. The selective recording layer 422 is made consistent with the Blu-ray Disc standard, including the recording capacity (25 GB). The CD-R recording layer 420 is made consistent with the CD-R standard for write-once recording.

One of the sides of the spacer polycarbonate substrate layer 430 has a groove 430A which is intended to receive the selective recording layer 422. The other side thereof has a groove 430B which is intended to receive the CD-R recording layer 420.

As shown enlarged in FIG. 6C, the CD-R recording layer 420 has an organic dye recording film 420A which is deposited in the groove 430B and land of the spacer polycarbonate substrate layer 430, and a reflective film 420B which is deposited on this organic dye recording film 420A. When the organic dye recording film 420A is irradiated with laser light of high power, it causes a chemical change of state for information recording. It should be appreciated that since the organic dye causes an irreversible chemical change, it is impossible to rewrite previously-recorded areas. That is, this recording film is of write-once type. Azo-based or cyanine-based organic dyes are used for the purpose of optimization so as to react to the laser wavelength of 780 nm for use in the CD-R standard with high sensitivity. The reflective film 420B is made of a metallic material, and has the function of reflecting the laser light.

When recording information on the selective recording layer 422 of the optical recording medium 401, the selective recording layer 422 is irradiated with pulses of the first recording layer Z that is set to the recording power level. In this instance, the beam spot is focused on the selective recording layer 422. Since the first laser light Z has a wavelength in the range of 400 to 410 nm and a numerical aperture in the range of 0.80 to 0.90, the selective recording layer 422 exhibits an extinction coefficient of 0.05 or higher. As a result, the selective recording layer 422 absorbs the light of the beam spot and converts it into heat efficiently, and information is recorded by the heat.

Now, when recording information on the CD-R recording layer 420, the CD-R recording layer 420 is irradiated with the third laser light Z that is set to the recording power level. The beam spot is focused on the CD-R recording layer 420. The third laser Z has a wavelength in the range of 770 to 795 nm and a numerical aperture in the range of 0.45 to 0.50. The third laser light Z is thus not focused on the selective recording layer 422, and this selective recording layer 422 exhibits an extinction coefficient of 0.5 or lower. The resulting small amount of light absorption by the selective recording layer 422 can avoid accidental writing. In the meantime, the laser light having a wavelength in the range of 770 to 795 nm is absorbed by the organic dye recording film 420A of the CD-R recording layer 420 effectively, and converted into heat to form recording marks.

According to the optical recording medium 401, a first laser optical system that supports the BD standard can be used to record and read information on/from the selective recording layer 422. In addition, a third laser optical system that supports the CD-R standard can be used to record information on the CD-R recording layer 420. Consequently, the one single recording medium 401 can be subjected to both BD-based writing and CD-R based writing at the same time.

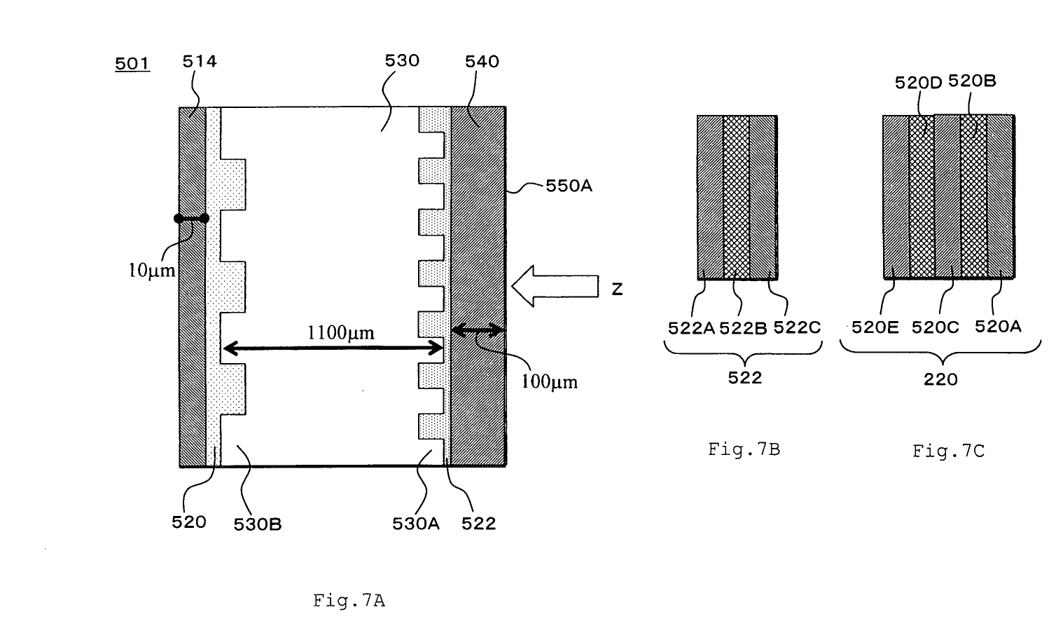

An optical recording medium 501 according to a sixth embodiment of the present invention will now be described with reference to FIG. 7. In the following description and drawings, components in the optical recording medium 501 that are similar or identical to those of the optical recording medium 301 described in the fourth embodiment will be designated by reference numerals with the same lower two digits. A description of each individual component will thus be omitted.

As shown in FIG. 7A, the optical recording medium 501 is configured to include a top coat layer 514, a CD-RW recording layer 520, a spacer polycarbonate substrate layer 530, a selective recording layer 522, and a light-transparent cover layer 540 which are stacked in this order. As shown in FIG. 7B, the selective recording layer 522 has exactly the same configuration as that of the fourth embodiment.

The spacer polycarbonate substrate layer 530 has a thickness of 1100 μm and keeps the selective recording layer 522 and the CD-RW recording layer 520 at a predetermined distance away from each other. The cover layer 540 has a thickness of approximately 100 μm.

In the optical recording medium 501, the distance from the light incident surface 550A to the selective recording layer 522 is thus approximately 100 μm. The distance from the light incident surface 550A to the CD-RW recording layer 520 is approximately 1200 μm. The selective recording layer 522 is made consistent with the Blu-ray Disc standard, including the recording capacity (25 GB). The CD-RW recording layer 520 is made consistent with the CD-RW standard for rewritable recording.

One of the sides of the spacer polycarbonate substrate layer 530 has a groove 530A which is intended to receive the selective recording layer 522. The other side thereof has a groove 530B which is intended for the CD-RW recording layer 520.

As shown enlarged in FIG. 7C, the CD-RW recording layer 520 includes a protective film 520A, a phase change material film 520B, a protective film 520C, a reflective film 520D, and a protective film 520E. The protective film 520A is deposited in the groove 530B and land of the spacer polycarbonate substrate layer 530. The phase change material film 520B is deposited on this protective film 520A. The protective film 520C is deposited on this phase change material film 520B. The reflective film 520D is deposited on this protective film 520C. The protective film 520E is deposited on the reflective film 520D. When the phase change material film 520B is irradiated with laser light of high power, the phase change material is melted and cooled quickly. This brings the phase change material into an amorphous state (recorded state) resulting in a drop in reflectivity. If the phase change material is irradiated with laser light of medium power for gradual heating and gradual cooling, however, the phase change material enters a crystalline state (erased state) resulting in a return to a high reflectivity. Since the phase change material film 520B causes reversible changes, it is possible to rewrite previously-recorded areas.

When recording information on the selective recording layer 522 of the optical recording medium 501, the selective recording layer 522 is irradiated with pulses of the predetermined first laser light Z from a laser source that is set to the recording power level. In this instance, the beam spot irradiating through the cover layer 540 is focused on the selective recording layer 522. Since the first laser light Z has a wavelength in the range of 400 to 410 nm and a numerical aperture in the range of 0.80 to 0.90, the selective recording layer 522 exhibits an extinction coefficient of 0.05 or higher. As a result, the selective recording layer 522 absorbs the light of the beam spot and converts it into heat effectively, and information is recorded by the heat.

Now, when recording information on the CD-RW recording layer 520, the CD-RW recording layer 520 is irradiated with the third laser light Z that is set to a high power (recording power). In this instance, the beam spot is focused on the CD-RW recording layer 520. As a result, the phase change material film 520B of the CD-RW recording layer 520 is melted and cooled quickly to form recording marks. Similarly, the CD-RW recording layer 520 is irradiated with the third laser light Z of medium power (erasing power) to erase the information. Since the third laser light Z has a wavelength in the range of 770 to 795 nm and a numerical aperture in the range of 0.45 to 0.50, the selective recording layer 522 exhibits an extinction coefficient of 0.5 or lower. The resulting small amount of absorption of the third laser light Z by the selective recording layer 522 can avoid accidental writing.

According to the optical recording medium 501, a first laser optical system that supports the BD standard can be used to record and read information on/from the selective recording layer 522. In addition, a third laser optical system that supports the CD-RW standard can be used to record and erase information on/from the CD-RW recording layer 520. Consequently, the one single recording medium 501 can be subjected to both BD-based writing and CD-RW based writing at the same time.

### Example 1

The optical recording medium 1 corresponding to the first embodiment was actually manufactured for experiment. In the manufacturing process, a spacer polycarbonate substrate layer 30 having a thickness of 500 μm (=0.5 mm) was molded so that ROM pits that conforms to the conventional DVD standard were formed in one side and a groove that conforms to the BD standard was formed in the other side. A selective recording layer 22 made of TiO₂ (10 nm)/BiO_{2.1} (30 nm)/TiO₂ (10 nm) was formed on the groove side by sputtering. Subsequently, a 100-μm-thick light transparent layer made of ultraviolet curing resin was formed to serve as both the cover layer 40 and the hard coat layer 50. Then, a DVD-ROM recording layer 20 containing Al and 2.0-mol % Cr was formed to 100 nm on the ROM-pit side of the spacer polycarbonate substrate layer 30 by sputtering. Then, a dummy polycarbonate substrate 10 having a thickness of 600 μm (=0.6 mm) was adhered thereto via a 45-μm top coat layer 14 and an adhesive layer 12.

The medium manufactured in this way was tested using a DVD optical system tester with a wavelength of 650 nm and a numerical aperture of 0.60. Information was read from the DVD-ROM recording layer 20 from the side of the light transparent layer (being the cover layer 40 and the hard coat layer 50), with jitter as favorable as 7.0%. The same optical recording medium 1 was also tested using a BD optical system tester with a wavelength of 407 nm and a numerical aperture of 0.85. Recording and reading from the side of the light transparent layer (being the cover layer 40 and the hard coat layer 50) showed jitter of 6.5% under recording power conditions and recording strategies that conform to the BD standard.

### Example 2

The optical recording medium 101 corresponding to the second embodiment was actually manufactured for experiment. In the manufacturing process, a spacer polycarbonate substrate layer 130 having a thickness of 500 μm (=0.5 mm) was molded so that a groove that conforms to the DVD-R standard was formed in one side and a groove that conforms to the BD standard was formed in the other side. A selective recording layer 122 made of TiO₂ (10 nm)/BiO_{2.1} (30 nm)/TiO₂ (10 nm) was formed on the BD-groove side by sputtering. Subsequently, a 100-μm-thick light transparent layer made of ultraviolet curing resin was formed to serve as both the cover layer 140 and the hard coat layer 150. Next, the DVD-R groove side of the spacer polycarbonate substrate layer 130 was coated with an organic dye recording film 120A. A metal film 120B was deposited further, and a dummy polycarbonate substrate 10 was also adhered thereto.

The medium 101 manufactured in this way was tested using a DVD optical system tester with a wavelength of 650 nm and a numerical aperture of 0.65. When recorded and read under the recording power conditions and recording strategies that conform to the DVD-R standard, the DVD-R recording layer 120 showed jitter of 7.3%. The same optical recording medium 101 was also tested using a BD optical system tester with a wavelength of 407 nm and a numerical aperture of 0.85. Recording and reading showed jitter of 6.5% under the recording power conditions and recording strategies that conform to the BD standard.

### Example 3

The optical recording medium 201 corresponding to the third embodiment was actually manufactured for experiment. In the manufacturing process, a spacer polycarbonate substrate layer 230 having a thickness of 500 μm (=0.5 mm) was molded so that a groove that conforms to the DVD-RW standard was formed in one side and a groove that conforms to the BD standard was formed in the other side. A selective recording layer 222 made of TiO₂ (10 nm)/BiO_{2.1} (30 nm)/TiO₂ (10 nm) was formed on the BD-groove side of the spacer polycarbonate substrate layer 230. Subsequently, a 100-μm-thick light transparent layer made of ultraviolet curing resin was formed to serve as both the cover layer 240 and the hard coat layer 250. Next, a DVD-RW recording layer 220 having a multilayered structure was formed on the DVD-RW groove side of the spacer polycarbonate substrate layer 230. A dummy polycarbonate substrate 210 was also adhered thereto.

The medium 201 manufactured in this way was tested using a DVD optical system tester with a wavelength of 650 nm and a numerical aperture of 0.65. When recorded and read under the recording power conditions and recording strategies that conform to the DVD-RW standard, the DVD-RW recording layer 220 showed jitter of 6.8%. The same optical recording medium 201 was also tested using a BD optical system tester with a wavelength of 407 nm and a numerical aperture of 0.85. Recording and reading showed jitter of 6.5% under the recording power conditions and recording strategies that conform to the BD standard.

### Example 4

The optical recording medium 301 corresponding to the fourth embodiment was actually manufactured for experiment. In the manufacturing process, a spacer polycarbonate substrate layer 330 having a thickness of 1100 μm (=1.1 mm) was molded so that ROM pits conforming to the CD standards were formed in one side and a groove conforming to the BD standard was formed in the other side. A selective recording layer 322 made of TiO₂ (10 nm)/BiO_{2.1} (30 nm)/TiO₂ (10 nm) was formed on the groove side by sputtering. Subsequently, a 100-μm-thick light transparent layer made of ultraviolet curing resin was formed as the cover layer 340. Next, a CD-ROM recording layer 320 containing Al and 2.0-mol % Cr was formed to 100 nm on the ROM-pit side of the spacer polycarbonate substrate layer 330 by sputtering. Then, a 10-μm-thick top coat layer 314 was formed.

The medium 301 manufactured in this way was tested using a CD optical system tester with a wavelength of 780 nm and a numerical aperture of 0.50. Information was read from the CD-ROM recording layer 320 from the side of the light transparent layer (the cover layer 340), with jitter as favorable as 6.0%. The same optical recording medium 301 was also tested using a BD optical system tester a wavelength of 407 nm and a numerical aperture of 0.85. Recording and reading from the side of the cover layer 340 showed jitter of 6.5% under the recording power conditions and recording strategies that conform to the BD standard.

### Example 5

The optical recording medium 401 corresponding to the fifth embodiment was actually manufactured for experiment. In the manufacturing process, a spacer polycarbonate substrate layer 430 having a thickness of 1100 μm (=1.1 mm) was molded so that a groove that conforms to the CD-R standard was formed in one side and a groove that conforms to the BD standard was formed in the other side. A selective recording layer 422 made of TiO₂ (10 nm)/BiO_{2.1} (30 nm)/TiO₂ (10 nm) was formed on the BD-groove side by sputtering. Subsequently, a 100-μm-thick light transparent layer made of ultraviolet curing resin was formed as the cover layer 440. Next, the CD-R groove side of the spacer polycarbonate substrate layer 430 was coated with an organic dye recording film 420A, followed by a metal film 420B. A topcoat layer 414 was formed thereon.

The medium 401 manufactured in this way was tested using a CD optical system tester a wavelength of 780 nm and a numerical aperture of 0.50. Under the recording power conditions and recording strategies that conform to the CD-R standard, the CD-R recording layer 420 was recorded and read from the side of the light transparent layer (the cover layer 340), with jitter of 5.8%. The same optical recording medium 401 was also tested using a BD optical system tester with a wavelength of 407 nm and a numerical aperture of 0.85. Recording and reading showed jitter of 6.5% under the recording power conditions and recording strategies that conform to the BD standard.

### Example 6

The optical recording medium 501 corresponding to the sixth embodiment was actually manufactured for experiment. In the manufacturing process, a spacer polycarbonate substrate layer 530 having a thickness of 1100 μm (=1.1 mm) was molded so that a groove that conforms to the CD-RW standard was formed in one side and a groove that conforms to the BD standard was formed in the other side. A selective recording layer 522 made of TiO₂ (10 nm)/BiO_{2.1} (30 nm)/TiO₂ (10 nm) was formed on the BD-groove side of this spacer polycarbonate substrate layer 530. Subsequently, a 100-μm-thick light transparent layer made of ultraviolet curing resin was formed as the cover layer 540. Next, a CD-RW recording layer 520 having a multilayered structure was formed on the CD-RW groove side of the spacer polycarbonate substrate layer 530. A top coat layer 514 was formed further.

The medium 501 manufactured in this way was tested using a CD optical system tester that conforms to the CD-RW standard with a wavelength of 780 nm and a numerical aperture of 0.50. When recorded and read under the recording power conditions and recording strategies that conform to the CD-RW standard, the CD-RW recording layer 520 showed jitter of 5.8%. The same optical recording medium 501 was also tested using a BD optical system tester with a wavelength of 407 nm and a numerical aperture of 0.85. Recording and reading showed jitter of 6.5% under the recording power conditions and recording strategies that conform to the BD standard.

The foregoing embodiments have dealt with the cases where only one selective recording layer is located in the range of 40 and 120 μm away from the light incident surface. Nevertheless, the present invention is not limited to the one single layer, but a plurality of layers may be formed in that range. The provision of a plurality of recording layers allows so-called BD multilayer recording with an increase in the capacity of the write-once BD areas. Within the range of formation of the selective recording layer(s), the lower limit of 40 μm is a minimum value at which flaws and fingerprints on the surface of the optical recording medium have little effect on the recording and reading characteristics. The upper limit of 120 μm is a maximum value at which the objective lens of the BD optical system has an allowable spherical aberration.

The embodiments described above have also dealt only with the cases where the BD-specific selective recording layer is accompanied with a DVD-ROM recording layer, DVD-R recording layer, DVD-RW recording layer, CD-ROM recording layer, CD-R recording layer, or CD-RW recording layer. The present invention is not limited thereto, and may be applied to other recording modes that are compliant with CD or DVD standards. Moreover, factors such as configuration and materials have only to meet the DVD or CD standards, and it is possible to use other film materials and film configuration. Furthermore, the DVD or CD recording layer need not be one in number. A plurality of recording layers may be formed in the range of 570 to 630 μm or in the range of 1100 to 1300 μm. The provision of a plurality of layers allows so-called DVD or CD multilayer recording, with an increase in recording capacity. It should be appreciated that the range of 570 to 630 μm corresponds to the DVD standards, and the range of 1100 to 1300 μm the CD standards.

It is also understood that the optical recording medium of the present invention is not limited to the foregoing embodiments, and various modifications may be made without departing from the gist of the present invention.

The optical recording medium of the present invention is applicable to recording and reading of various types of information such as for authoring and archival applications.

The entire disclosure of Japanese Patent Application No. 2006-353758 filed on 28 Dec. 2006 including specification, claims, drawings, and summary are incorporated herein by reference in its entirety.

What is claimed is:

1. An optical recording medium comprising:
at least one recording layer located in the range of 40 to 120 μm away from a light incident surface, the recording layer having a light absorption characteristic which enables write-once recording using a laser optical system having a wavelength in the range of 400 to 410 nm and a numerical aperture in the range of 0.80 to 0.90 and having a light absorption characteristic which disables write-once recording using a laser optical system having a wavelength in the range of 620 to 660 nm and a numerical aperture in the range of 0.55 to 0.65; and
at least one recording layer located in the range of 570 to 630 μm away from the light incident surface, the recording layer exhibiting any one of information retention modes selected from among read-only, write-once, and rewritable using the laser optical system having a wavelength in the range of 620 to 660 nm and a numerical aperture in the range of 0.55 to 0.65.

2. The optical recording medium according to claims 1, wherein the recording layer located in the range of 40 to 120 μm away from a light incident surface includes at least a recording film made of bismuth oxide.

3. An optical recording medium comprising:
at least one optical recording layer located in the range of 40 to 120 μm away from a light incident surface, the optical recording layer having a light absorption characteristic which enables write-once recording using a laser optical system having a wavelength in the range of 400 to 410 nm and a numerical aperture in the range of 0.80 to 0.90 and having a light absorption characteristic which disables write-once recording using a laser optical system having a wavelength in the range of 770 to 795 nm and a numerical aperture in the range of 0.45 to 0.50; and
at least one recording layer located in the range of 1100 to 1300 μm away from the light incident surface, the recording layer exhibiting any one of information retention modes selected from among read-only, write-once, and rewritable using the laser optical system having a wavelength in the range of 770 to 795 nm and a numerical aperture in the range of 0.45 to 0.50.

4. The optical recording medium according to claims 3, wherein the recording layer located in the range of 40 to 120 μm away from a light incident surface includes at least a recording film made of bismuth oxide.

5. An optical recording medium comprising:
at least one recording layer located in the range of 40 to 120 μm away from a light incident surface, the recording layer having a light absorptance of 10% or higher when using a laser optical system having a wavelength in the range of 400 to 410 nm and a numerical aperture in the range of 0.80 to 0.90 and having a light transmittance of 70% or higher when using a laser optical system having a wavelength in the range of 620 to 660 nm and a numerical aperture in the range of 0.55 to 0.65; and
at least one recording layer located in the range of 570 to 630 μm away from the light incident surface, the recording layer exhibiting any one of information retention modes selected from among read-only, write-once, and rewritable using the laser optical system having a wavelength in the range of 620 to 660 nm and a numerical aperture in the range of 0.55 to 0.65.

6. The optical recording medium according to claims 6, wherein the recording layer located in the range of 40 to 120 μm away from a light incident surface includes at least a recording film made of bismuth oxide.

7. An optical recording medium comprising:
at least one recording layer located in the range of 40 to 120 μm away from a light incident surface, the recording layer having a light absorptance of 10% or higher when using a laser optical system having a wavelength in the range of 400 to 410 nm and a numerical aperture in the range of 0.80 to 0.90 and having a light transmittance of 70% or higher when using a laser optical system having a wavelength in the range of 770 to 795 nm and a numerical aperture in the range of 0.45 to 0.50; and
at least one recording layer located in the range of 1100 to 1300 μm away from the light incident surface, the recording layer exhibiting any one of information retention modes selected from among read-only, write-once, and rewritable using the laser optical system having a wavelength in the range of 770 to 795 nm and a numerical aperture in the range of 0.45 to 0.50.

8. The optical recording medium according to claims 7, wherein the recording layer located in the range of 40 to 120 μm away from a light incident surface includes at least a recording film made of bismuth oxide.

9. An optical recording medium comprising:
at least one first recording layer located in the range of 40 to 120 μm away from a light incident surface, the first recording layer including a recording film made of bismuth oxide and having a light absorptance of 10% or higher when using a laser optical system having a wavelength in the range of 400 to 410 nm and a numerical aperture in the range of 0.80 to 0.90; and
at least one recording layer located in the range of 570 to 630 μm away from the light incident surface, the recording layer exhibiting any one of information retention modes selected from among read-only, write-once, and rewritable using a laser optical system having a wavelength in the range of 620 to 660 nm and a numerical aperture in the range of 0.55 to 0.65.

10. An optical recording medium comprising:
at least one first recording layer located in the range of 40 to 120 p away from a light incident surface, the first recording layer including at least a recording film made of bismuth oxide and having a light absorptance of 10% or higher when using a laser optical system having a wavelength in the range of 400 to 410 nm and a numerical aperture in the range of 0.80 to 0.90; and
at least one recording layer located in the range of 1100 to 1300 μm away from the light incident surface, the recording layer exhibiting any one of information retention modes selected from among read-only, write-once, and rewritable using a laser optical system having a wavelength in the range of 770 to 795 nm and a numerical aperture in the range of 0.45 to 0.50.
